(19) United States
(12) Patent Application Publication
(10) Pub. No.: US 2006/0077110 A1
(43) Pub. Date: Apr. 13, 2006

(54) Antenna and method for mounting an antenna on a vehicle by clipping, preferably produced by sliding

(75) Inventor: Gunther Blickle, Neustetten (DE)

Correspondence Address: THE FIRM OF KARL F ROSS, 5676 RIVERDALE AVENUE, PO BOX 900, RIVERDALE (BRONX), NY, 10471-0900, US

(73) Assignee: HIRSCHMANN CAR COMMUNICATION GMBH

(21) Appl. No.: 11/236,879

(22) Filed: Sep. 27, 2005

(30) Foreign Application Priority Data
Sep. 28, 2004 (DE) 102004046979.2
Sep. 19, 2005 (DE) 102005044611.6

(51) Int. Cl. H01Q 1/32

(52) U.S. Cl. 343/713; 343/906

(57) ABSTRACT

The invention relates to a device and a method of mounting an antenna, in particular a roof antenna (1), on a vehicle body (12) with a base plate (2) connected to the roof antenna (1) outside the vehicle body and with a support element inside the vehicle body that is threaded into the base plate (2), the support element being formed as a bayonet plate (6), that a threaded connection (screw 3) has a pressure spring (compression spring 5) that produces a force between the base plate (2) and the bayonet plate (6), that between the base plate (2) and bayonet plate (6) there are guide elements (bolts 8, slots 9) that permit a limited shifting of the base plate (2) relative to the bayonet plate, that the bayonet plate (6) has limiting elements (bumps 10) that fit with the hole in the vehicle body (triangular hole 11) and that between the base plate (2) and the bayonet plate (6) there are projections (13) with complementary seats (14) in the second part that in an offset position of the base plate (2) relative to the bayonet plate (6) space the base plate (2) from the bayonet plate (6) and in another position engage in the seats (14).

The invention relates to a vehicle antenna and a method of mounting the antenna on part of the vehicle according to the features of the characterizing clauses of the independent claims.

Such an antenna used for example as a roof antenna is normally mounted on the vehicle body by providing its base plate with a threaded stud that is fitted through a hole in the vehicle body, then from inside screwing a nut on the screwthreads of the stud to fix the base plate on the vehicle body. Such a mounting system requires two people to carry out, since one person must hold the roof antenna in position on the outside and another must use tools inside the vehicle to screw it tight.

The known roof antennas and their mounting are for today's assembly requirements too expensive and time consuming.

It is therefore an object of the invention to simplify the mounting of the antenna so that the mounting can be done without tools, without a second person, and without other aids. Instead the antenna should be simply mounted and fixed in the desired end position on the vehicle manner that is permanent, secure, and water-tight. It should further be possible to mount the antenna at any time from outside during assembly of the vehicle, even when the roof liner has already been installed.

This object is attained by the features of claim 1.

According to the invention the support element is mounted on the base plate of the antenna such that during mounting or after mounting a sliding movement effects a gripping of the vehicle part without the use of a tool and furthermore that it is so constructed that the antenna after mounting is in the desired end position, cannot move, and is sealed to the vehicle part.

The invention is based on the idea of replacing the known connections, as for example screw connections, snap connections, and the like, with a gripping system that is effected during and/or after fitting of the antenna to the vehicle part. In this manner it is possible for one person to mount the antenna in a simple manner, without for example having to have a second parson fit a nut on a threaded stud while the first person holds the antenna in position on the vehicle part. This reduces the number of parts and even eliminates use of an installation tool in a very advantageous manner. The substantial advantage is that not only can a single person install the antenna, in fact in a single step by passing the support element carried on the base plate through an opening in the vehicle part and then moving the antenna in a combined sliding and pivoting movement that this movement or its completion creates the gripping action, and the support element is furthermore so constructed that no further action is necessary and the antenna is left in the desired end position, fixedly mounted, and sealed. Preferably in this position the gripping force is maximized.

The gripping force is effected by a sliding action, with a longitudinal shifting of the antenna, in particular its base plate, relative to the vehicle body. This is distinguished from the threading of a nut on the known threaded stud which is not understood as a pivoting movement. Similarly the gripping action is not the same as an adhesive mounting.

Furthermore according to the invention a lower face of the base plate carries a bayonet plate that can be passed in a predetermined direction through a complementary hole in the vehicle part on mounting of the antenna and that moves underneath the vehicle part to spatially overlap it such that movement of the bayonet plate out of the hole of the vehicle part in a direction perpendicular to the upper face of the vehicle part is no longer possible. Making the support element a bayonet plate has the advantage that the antenna can be mounted on the vehicle part by a simple series of steps. To this end the vehicle part has a hole that fits with the outer shape of the support element so that fitting the support element through the hole of the vehicle part in the wrong position of the antenna is not possible but, once the desired end position of the antenna on the vehicle is reached, withdrawal is impossible. The interaction of the shape of the hole in the vehicle part and the outer shape of the support element or its bayonet plate makes it possible for the antenna to be first fitted in an incorrect position through the hole in the vehicle part and then shifted to create the gripping force that secures it during and/or after further sliding movement on the vehicle part. This predetermined sequence of steps (for example fitting the antenna from above into the hole and then sliding it) makes it possible for a single person to install the antenna on the vehicle part in the desired manner.

In a further embodiment of the invention on continuing to move in the predetermined mounting direction on the antenna reaching the desired end position on the vehicle body there is an automatic gripping of the vehicle part and a compression of a seal between the antenna and the vehicle part. Such a construction has the advantage that the antenna is fitted through the hole in the vehicle part and pivoted until the desired end position of the antenna on the vehicle part is attained. Only when this desired position is attained, is the gripping force (prestressing) automatically triggered so as to pull the base plate with the seal tightly against the vehicle part. This has the advantage that the seal is not evvective until the antenna is in the desired position on the vehicle part in order to ensure a relatively easy movement between the vehicle part and the antenna. Only when the desired position of the antenna is reached is the gripping action triggered, aided by the seal, so that the antenna is not only solidly mounted on the vehicle part but can accommodate some tolerance variations.

Furthermore according to the invention a spring element is provided that produces the necessary gripping force by means of a prestressed spring element. This spring element can be a spiral spring, a spring washer, or a stack of spring washers.

As already stated, according to the invention there is the following sequence of steps for mounting: fitting at an angle of the support element through the hole in the vehicle part and then sliding forward and backward so that the support element triggers the gripping action with the vehicle part.

It is furthermore provided that the support element is formed as a bayonet plate, that a threaded connection has a pressure spring that produces a force between the base plate and the bayonet plate, that between the base plate and bayonet plate there are guide elements that permit a limited shifting of the base plate relative to the bayonet plate, that the bayonet plate has limiting elements that fit with the hole in the vehicle body and that between the base plate and the bayonet plate there are projections with complementary seats in the second part that in an offset position of the base plate relative to the bayonet plate space the base plate from the bayonet plate and in another position engage in the seats. This is therefore a device that has all the parts for mounting on the vehicle. The device is complete, with no need to separately stock the support element or nut. All the required parts are permanently mounted on the antenna.

In a further embodiment of the invention the guide is slots in the base plate or preferably in the bayonet plate that interfit with bolts that are fixed on the bayonet plate or preferably on the base plate. In this manner the base plate and the bayonet plate slide limitedly relative to each other in the slots, in a manner whose significance is detailed below.

The limiting elements are bumps on the bayonet plate that project toward the base plate and that are at least partly set within the outline of the bayonet plate.

The hole in the vehicle body is generally triangular and the limiting elements are arrayed on a triangle. A triangle gives the largest possible hole in the vehicle body. In addition fitting the cable with pins and the like to the antenna, in particular a roof antenna, is substantially simplified.

The bumps of the limiting elements are formed as spacers so as to simplify and eliminate the need for separate spacers and limiting elements. The limiting/spacer elements can also act as guide elements, further simplifying the structure.

The bayonet plate is also generally triangular and conforms to the triangular hole in the vehicle part. On one edge it has a portion on one edge that is bent away from the base plate and that is narrower than the respective side of the triangular hole.

The screw connection is a screw that is threaded into the base plate. It can also pass through and have a nut. Between the base plate and the screw head or a washer therein there can be a spacer sleeve that is surrounded by a compression spring and so as to exert a spring force between the bayonet plate and the base plate. The bayonet plate has a sleeve slot that is elongated parallel to the slots for the guide elements so that some limited relative movement is possible between the bayonet plate and base plate.

Mounting of the device according to one of the preceding claims on a vehicle body is done by the following steps: First the bayonet plate is mounted on the base plate such that the limiting elements produce a space with the base plate, that is the limiting elements push against the base plate or vice versa. The roof antenna with the bayonet plate is then fitted with the bent-down portion and then fully through the triangular hole in the vehicle body and is them shifted longitudinally such that the limiting elements align over the triangular hole and the a edge of the bayonet plate engages in the vehicle-body hole. This arrests the bayonet plate in the triangular hole, at least in the direction in which the base plate is subsequently shifted. Then the base plate or the roof antenna is shifted so far along the guide slots and the sleeve slot that the spacers engage in their seats and the bumps in their seats. At this point the full spring force is effective between the bayonet plat and the base plate and the base plate is pulled down against the vehicle body so that the seal or seal strips on the base plate are pressed against the vehicle-body surface. On the upper side opposite the base plate points can be provided that engages from inside on the vehicle body so as to pierce through the inner paint layer and form a good ground connection.

Instead of the points a separate intermediate plate or layer can be provided on the bayonet plate that produces the ground contact. Once the spacer elements are fitted in their seats the base plate or the roof antenna is solidly fixed relative to the bayonet plate. The bayonet plate for its part is secured by the limiting elements in the roof opening so that an exactly positioned and permanent mounting of the roof antenna on the vehicle body is achieved. The securing and mounting are effected by a series of steps that require no aids or tools and that can be effected by a single person or installer.

In order to uninstall the device without damaging it, a tool is proposed having a base body with two fork-like bars whose thickness generally corresponds to a height of the spacers. The base body has at least one and preferably two handles, to make it easy to manipulate.

To uninstall the tool with the bars is slid between the vehicle body and the base plate until the spacer elements and/or the bumps are lifted out of the seats. Then the base plate is shifted relative to the bayonet plate so far that the spacer elements and/or the bumps bear on the bayonet plate. This spaces the base plate from the bayonet plate. The roof antenna with the base plate and bayonet plate is then pulled or pivoted out of the triangular hole so that the electrical connections with the antenna can be undone. Naturally it is also possible to uninstall the roof antenna by unscrewing the parts from each other when one has access from inside the vehicle.

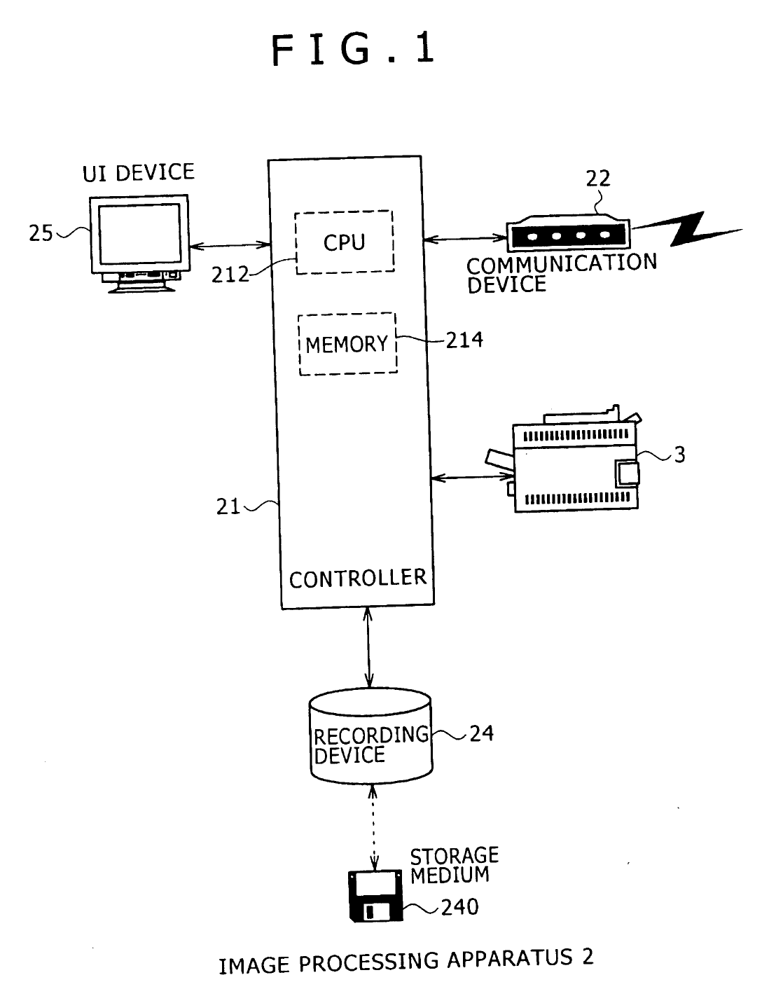

An embodiment of the invention to which it is not limited in shown in FIGS. 1 to 5 and described below.

Therein:

FIG. 1 is a section through a roof antenna and mount and a section through the vehicle body;

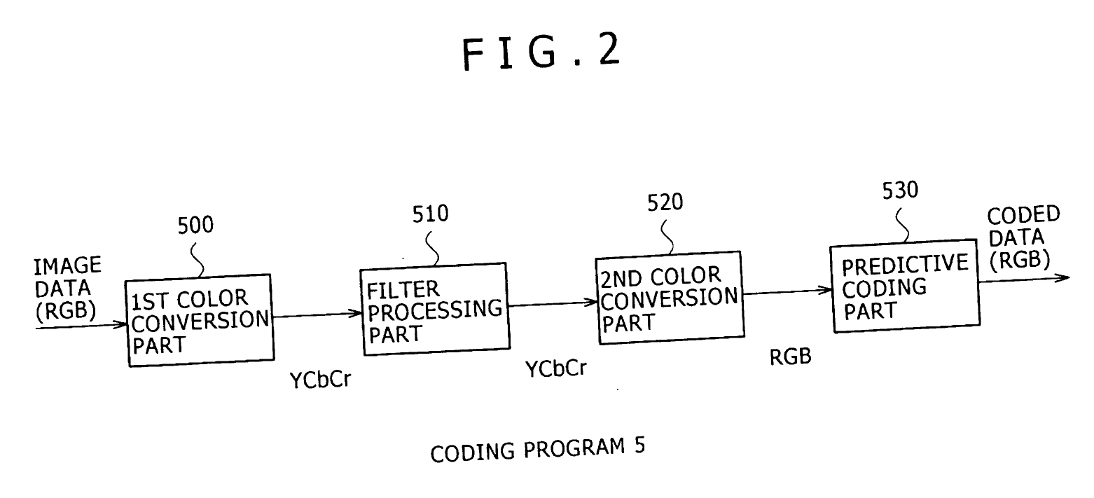

FIG. 2 is a view from below of the roof antenna and mount;

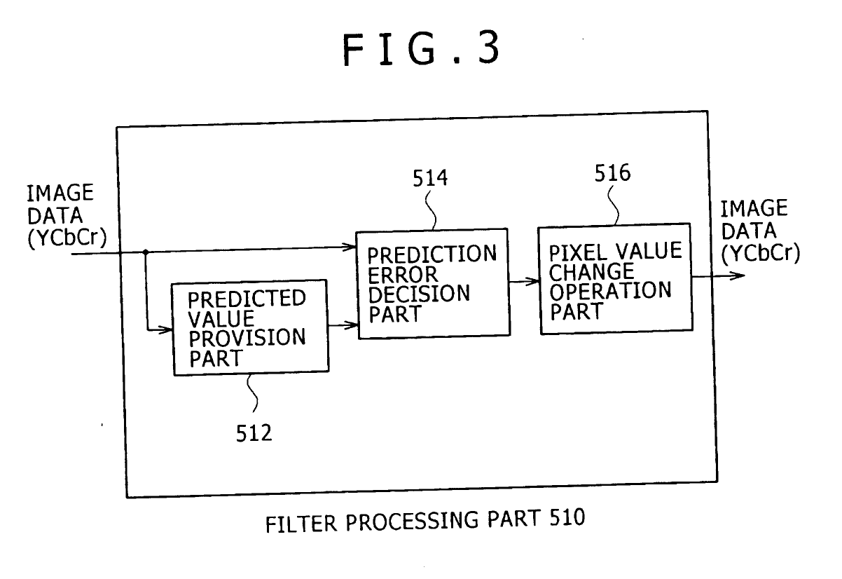

FIG. 3 is an exploded view of a roof antenna and mount and vehicle body at an angle from above;

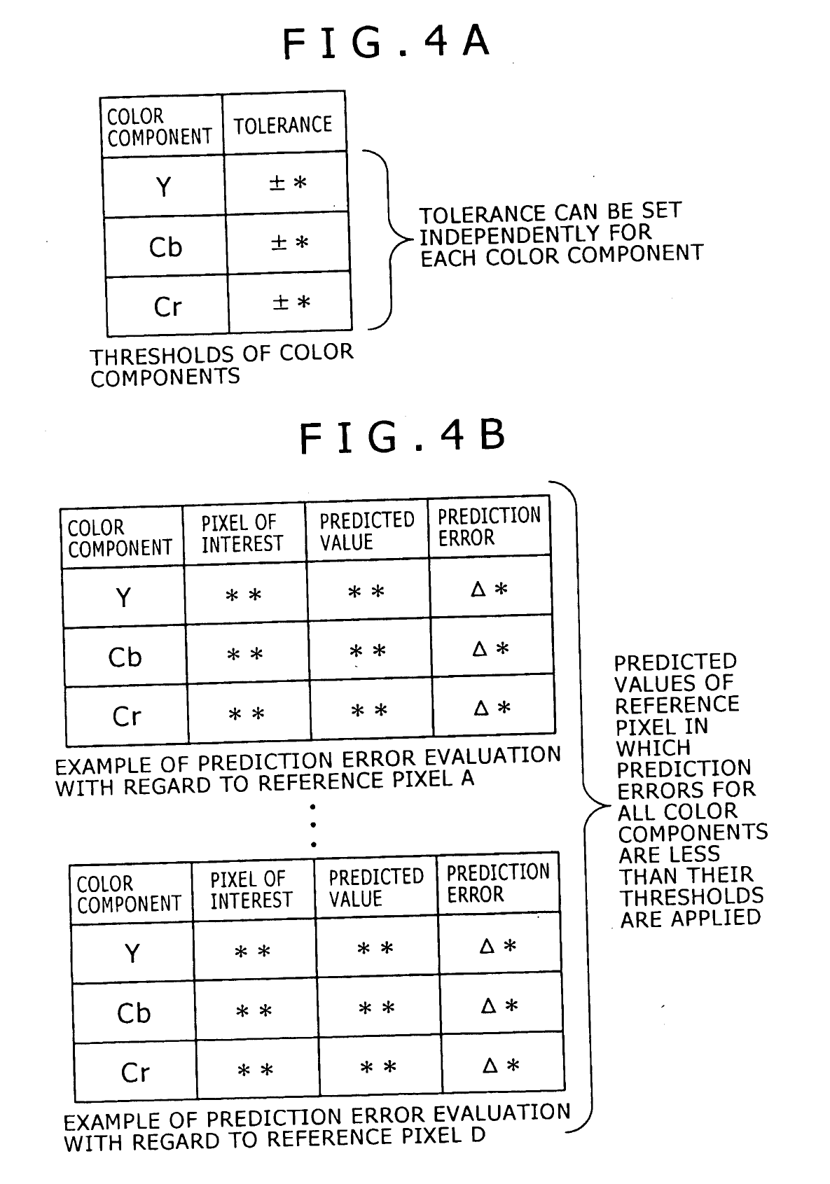

FIG. 4 is an exploded view of a roof antenna and mount and vehicle body at an angle from below; and

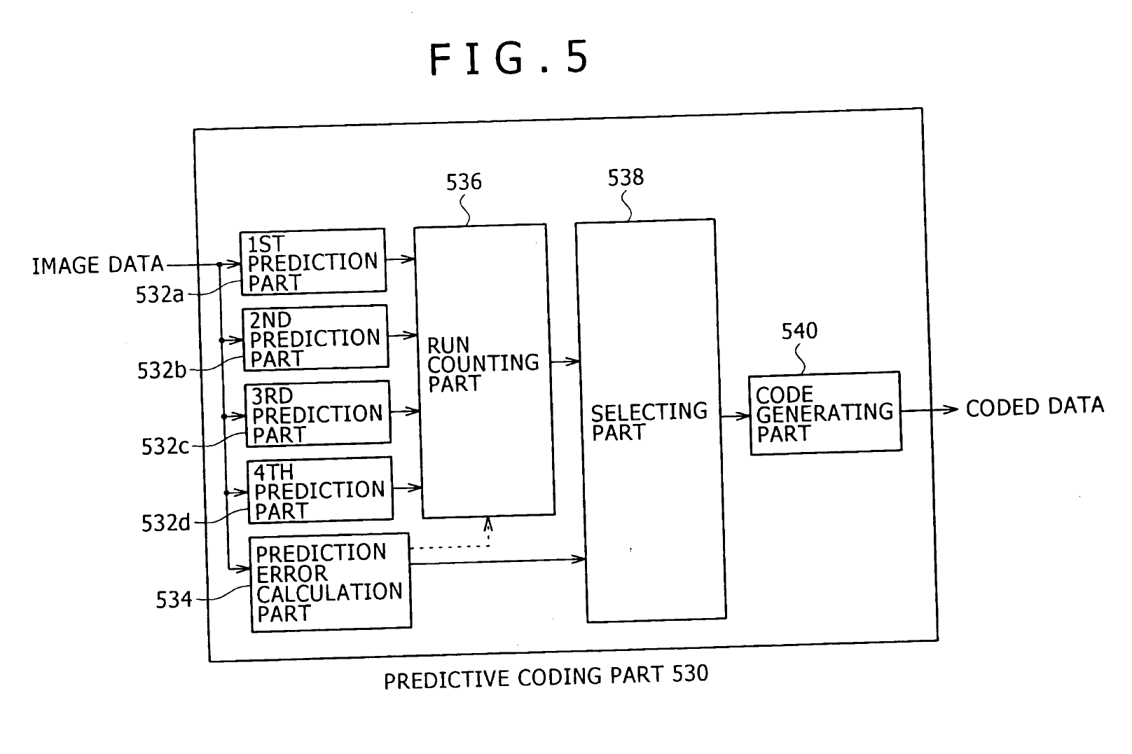

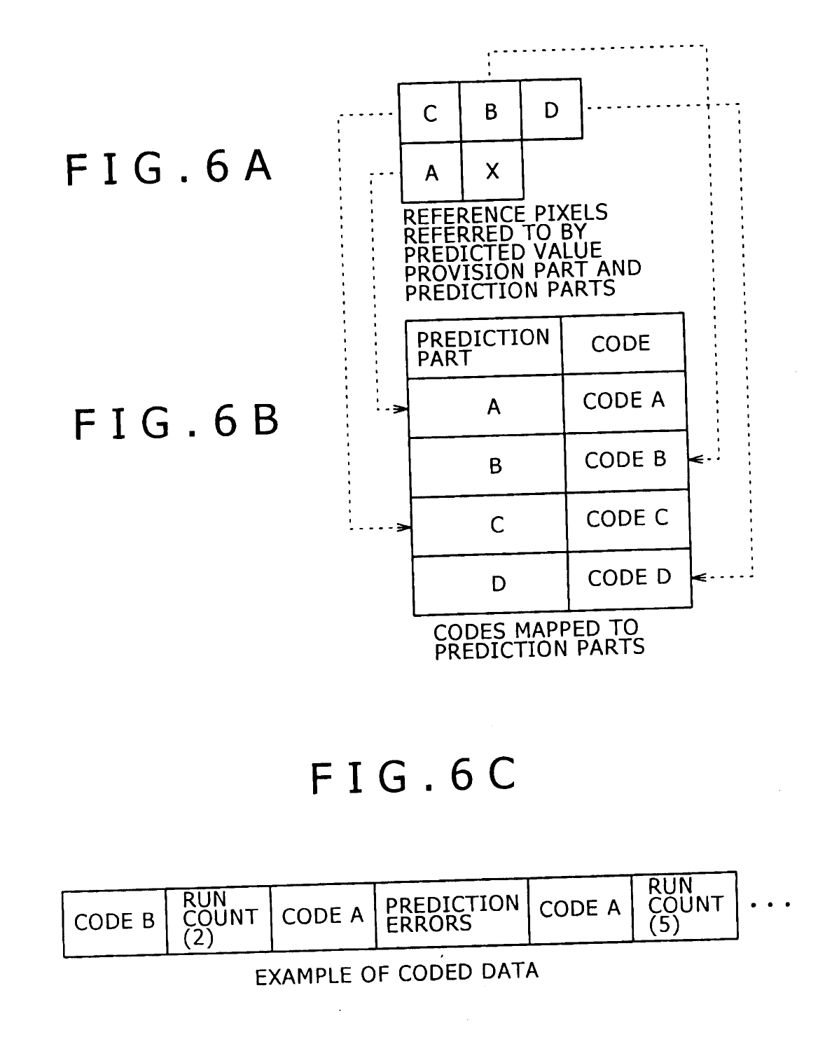

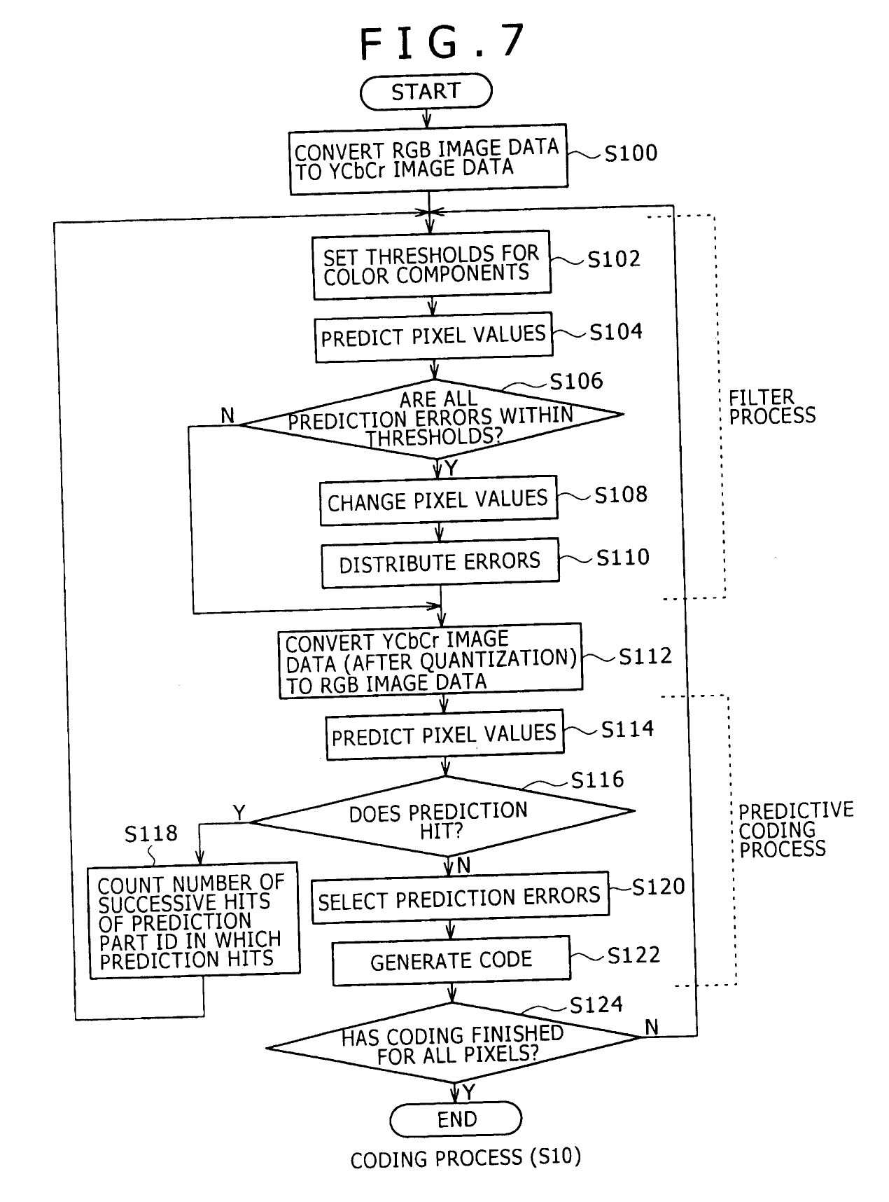

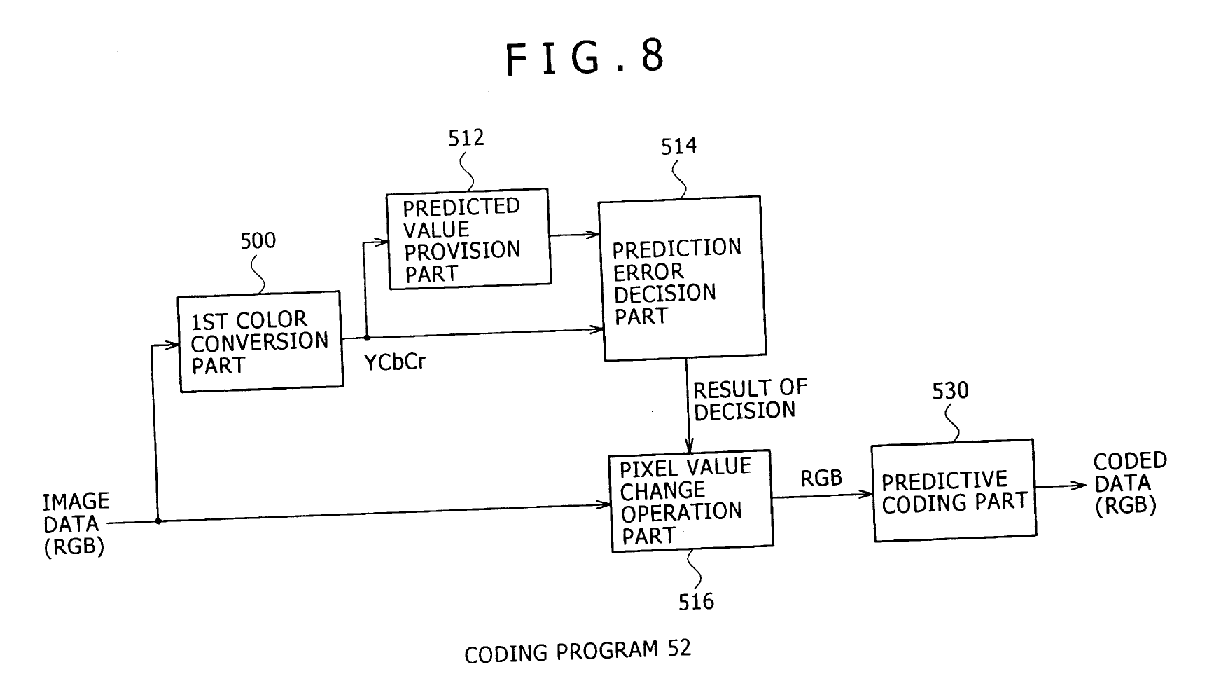

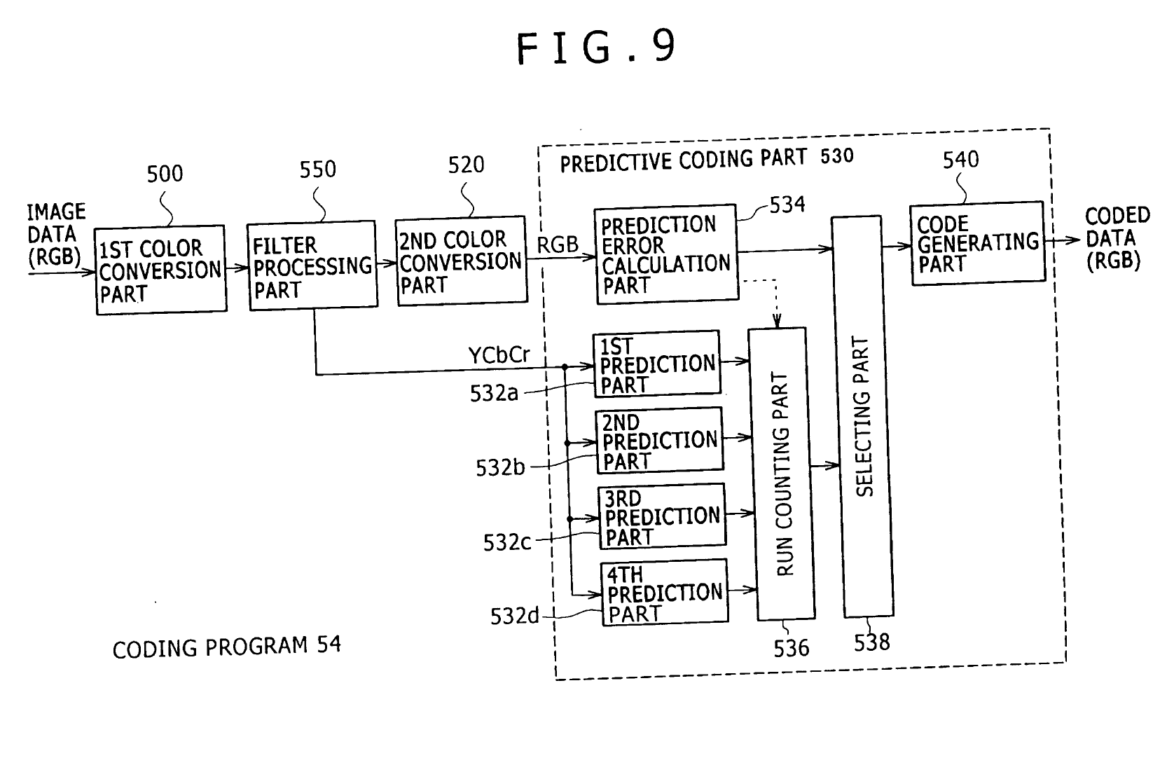

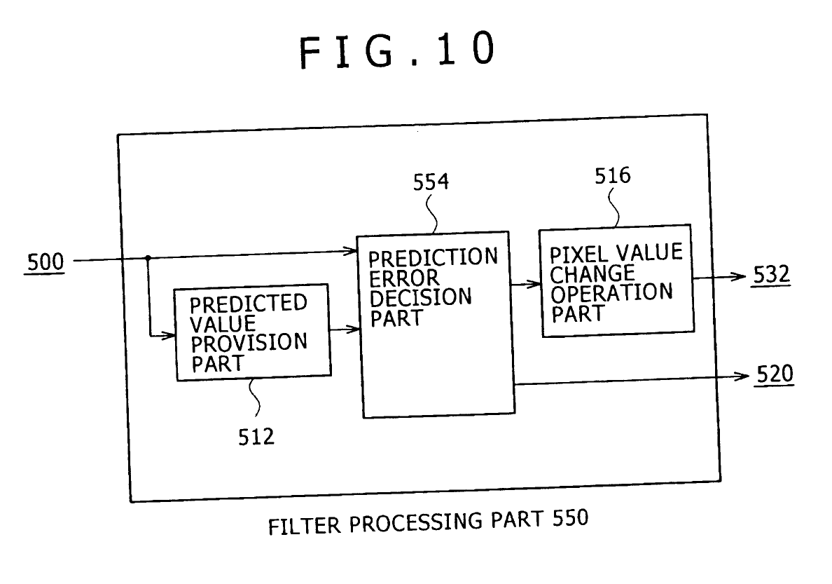

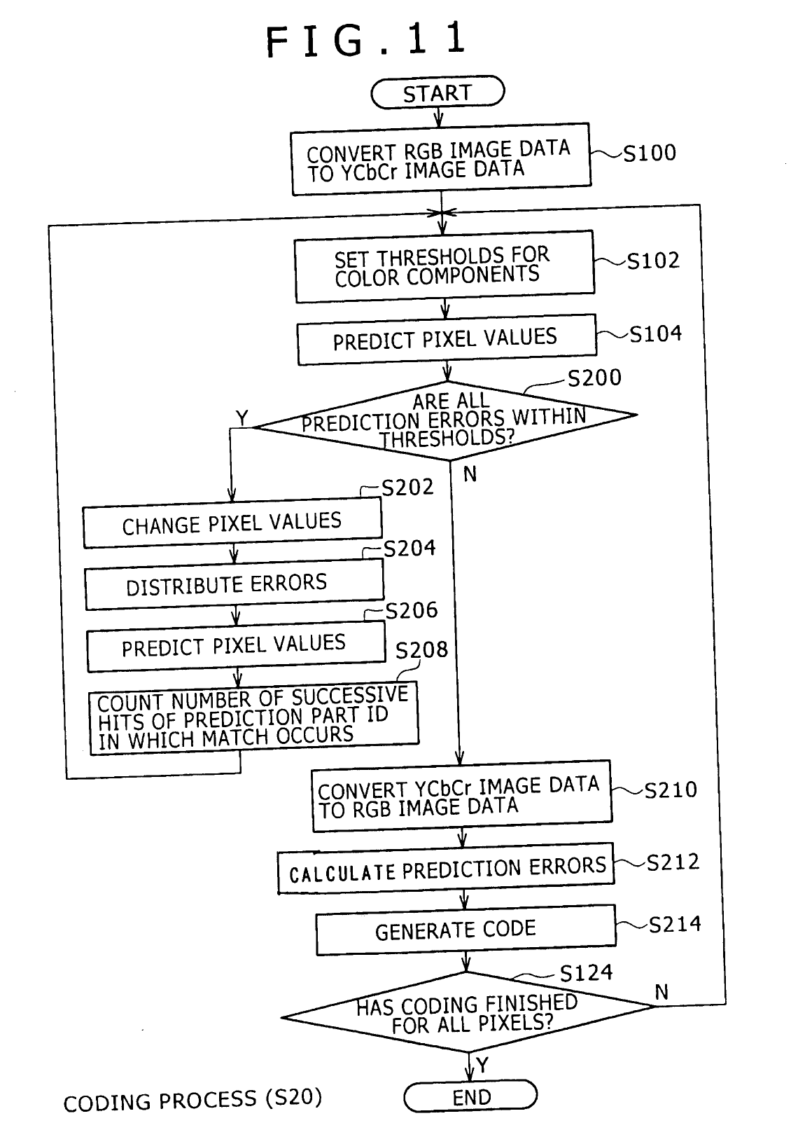

FIG. 5 is a top view of a roof antenna with its removal tool.

FIGS. 1 to 5 show in detail a roof antenna 1 comprised of a cover and-electric components and a base plate 2. The base plate 2 has a threaded collar in which a screw 3 is threaded. The base plate is formed with a spacer sleeve 4 so that the screw 3 can only be screwed in for a predetermined length. Around the spacer sleeve 4 there is a compression spring 5 that bears at one end on a washer and at the other end on a bayonet plate 6. The bayonet plate 6 is formed with a sleeve slot 7 that fits around the spacer sleeve 4 (see FIG. 2) and that permits limited displacement of the bayonet plate 6 relative to the base plate 2. Further bolts 8 (visible in FIGS. 2 and 4) on the base plate extend through slots 9 in the bayonet plate 6. The bolts 8 and the slots 9 form a guide. The bayonet plate 6 also (see in particular FIGS. 3 and 4) has bumps 10 that are positioned to fit in a triangular hole 11 in a vehicle body 12. The base plate 2 further carries spacers 13 that extend into seats 14 when the bayonet plate 6 has a predetermined position relative to the base plate 2. Seats 14 in the base plate 2 are also provided for the bumps 10 of the bayonet plate 6 so that the limiting elements also have the function of the spacers 13. The bayonet plate 6 has at one end a bent-down edge portion 15 that is shaped such that it projects away from the base plate 2.

As shown in FIGS. 1, 2, and 3 an antenna cable 16 can fit at any place through the relatively large triangular hole 11 in the car body 12 so that the antenna 1 can easily be installed.

FIG. 5 shows a tool 17 having two bars 18 fixed together by a bight body 19. The body 19 has handles 20 that make it easy to use the tool 17. As shown on the right side of FIG. 5, the tool 17 can be slid between the base plate 2 and the car body 12. It lifts the base plate 2 against the force of the compression spring 5 away from the vehicle body 2 so that the roof antenna 1 and the base plate 2 can be slid opposite to the install direction such that the bayonet plate 6 by means of the bumps 10 and the spacers 13 is spaced so far from the base plate 2 that it is easy to remove. The tool is preferably made of a soft plastic so that it does not damage the finish of the car body.

### REFERENCE LIST

roof antenna 1
The base plate 2
screw 3
spacer sleeve 4
compression spring 5
bayonet plate 6
sleeve slot 7
bolts 8
slots 9
bumps 10
triangular hole 11
vehicle body 12
spacers 13
seats 14
bent-down edge 15
cable 16
tool 17
bars 18
bight body 19
handles 20

1. An antenna (1), in particular a roof antenna, of a vehicle with a mounting element for securing the antenna (1) to a vehicle part (17a), the antenna (1) having a base plate (2) that carries a mounting element that fits through a hole in a vehicle part (17a), characterized in that during mounting or after mounting a sliding movement effects a gripping of the vehicle part (17a) without the use of a tool and furthermore that it is so constructed that the antenna (1) after mounting is in the desired end position, cannot move, and is sealed to the vehicle part (17a).

2. The antenna (1) according to claim 1, characterized in that a lower face of the base plate (2) carries a bayonet plate (9) that can be passed in a predetermined direction through a complementary hole in the vehicle part (17a) on mounting of the antenna (1) and that moves underneath the vehicle part (17a) to spatially overlap it such that movement of the bayonet plate (9) out of the hole of the vehicle part (17a) in a direction perpendicular to the upper face of the vehicle part (17a) is no longer possible.

3. The antenna (1) according to on claim 1, characterized in that on continuing to move in the predetermined mounting direction beyond fitting of the antenna (1) in the desired end position on the vehicle body (17a) there is an automatic gripping of the vehicle part (17) and a compression of a seal between the antenna (1) and the vehicle part (17a).

4. The antenna (1) according to claim 1, characterized in that a spring element is provided that produces the necessary gripping force by a prestressed spring element.

5. The antenna (1) according to claim 4, characterized in that the spring element is a spiral spring, a spring washer, or a stack of spring washers.

6. The antenna (1) according to claim 4, characterized in that the spring element and the bayonet plate (9) form a single unit.

7. The antenna (1) according to claim 1, characterized in that assembly is effected by the following steps: transverse fitting of the support element, in particular the bayonet plate (9), through the opening in the vehicle part (17a) and subsequent engagement under the vehicle part (17) by means of pivoting movement.

8. The antenna (1) according to claim 1, characterized in that the support element is formed as a bayonet plate (6), that a threaded connection (screw 3) has a pressure spring (compression spring 5) that produces a force between the base plate (2) and the bayonet plate (6), that between the base plate (2) and bayonet plate (6) there are guide elements (bolts 8, slots 9, spacer sleeve 4, sleeve slot 7) that permit a limited shifting of the base plate (2) relative to the bayonet plate, that the bayonet plate (6) has limiting elements (bumps 10) that fit with the hole in the vehicle body (triangular hole 11) and that between the base plate (2) and the bayonet plate (6) there are projections (13) with complementary seats (14) in the second part that in one position of the base plate (2) relative to the bayonet plate (6) space the base plate (2) from the bayonet plate (6) and in another position engage in the seats (14).

9. The antenna (1) according to claim 8, characterized in that the guide is slots (9) in the base plate (2) or preferably in the bayonet plate (6) that interfit with bolts (8) that are fixed on the bayonet plate (6) or preferably on the base plate (2).

10. The antenna (1) according to claim 8, characterized in that the limiting elements are bumps (10) on the bayonet plate (6) that project toward the base plate (2).

11. The antenna (1) according to claim 1, characterized in that the hole in the vehicle body is generally triangular (triangular hole 11) and that the limiting elements (bumps 10) are arrayed on a triangle.

12. The antenna (1) according to claim 10, characterized in that the bumps (10) of the limiting elements are formed as projections (13).

13. The antenna (1) according to claim 1, characterized in that the bayonet plate (6) is generally triangular and has a portion (15) on one edge bent away from the base plate (2).

14. The antenna (1) according to claim 1, characterized in that the screw connection is a screw (3) that is threaded into the base plate (2) and that is surrounded by a compression spring (5) and that the bayonet plate (6) has a sleeve slot (7) that is elongated parallel to the slots (9) for the guide elements.

15. The antenna (1) according to claim 14, characterized in that between the base plate (2) and a head of the screw or a washer thereon there is a spacer sleeve (4).

16. A method of mounting an antenna (1) according claim 1 on a vehicle body, characterized in that the bayonet plate (6) is mounted on the base plate (2) such that the limiting elements (bumps 10, spacers 13, seats 14) produce a space with the base plate (2), that the bayonet plate (6) is fitted first with the bent-down portion (15) and then fully through the triangular hole (11) in the vehicle body (12) and is them shifted longitudinally (1) such that the limiting elements (bumps 10, spacers 13, seats 14) align over the triangular hole (11) and that then the base plate (2) is shifted so far along the slots (2) and the slot (7) that the spacers (13) engage in the seats (14) and the bumps (10) in the seats (14).

17. A tool for uninstalling the antenna (1) according to claim 1 from a vehicle body, characterized by a base body (19) with two fork-like bars (18) whose thickness generally corresponds to a height of the spacers (13) and with at least one handle (20), the bars (18) having flattened outer ends.

18. A method of uninstalling an antenna according to claim 17 from a vehicle body, characterized in that the tool (17) with the bars (18) is slid between the vehicle body (12) and the base plate (2) until the spacer elements (13) and/or the bumps (10) are lifted out of the seats (14), that the base plate (2) is shifted relative to the bayonet plate (6) so far that the spacer elements (13) and/or the bumps (10) bear on the bayonet plate (6) and that the roof antenna (1) with the base plate (2) and bayonet plate (6) are pulled out of the triangular hole (11).
